(19) United States
(12) Patent Application Publication
(10) Pub. No.: US 2017/0175417 A1
(43) Pub. Date: Jun. 22, 2017

(54) Door Strike Plate with Adjustable Subplate

(71) Applicant: Easy Latch, LLC, Chesapeake, VA (US)

(72) Inventor: Jonathan Sweeten, Chesapeake, VA (US)

(73) Assignee: Easy Latch, LLC, Chesapeake, VA (US)

(21) Appl. No.: 15/376,874

(22) Filed: Dec. 13, 2016

Related U.S. Application Data
(60) Provisional application No. 62/268,166, filed on Dec. 16, 2015.

(51) Int. Cl. E05B 15/02

(52) U.S. Cl. CPC E05B 15/0255; E05B 15/0205; E05B 2015/023

(57) ABSTRACT

An apparatus and method for adjusting a door latching mechanism is shown and illustrated. The apparatus comprises a subplate and a strike plate. The subplate is installed against a door frame at latching location underneath the strike plate. The subplate has a front side and a rear side with different widths and defining a bolt aperture. The user can install the subplate in any variation to present an additional latching edge to a latch bolt. In addition, the subplate may have an adjustable tab which may be positioned inward toward the door frame or outward away from the door frame. The adjustable tab presents an additional latching edge for the latch bolt.

### PRIORITY

This application claims priority to, and fully incorporates, U.S. Provisional Patent Application Ser. No. 62/268,166 filed on Dec. 16, 2015.

### FIELD OF THE INVENTION

This field pertains generally to door latching mechanisms and more specifically to a subplate and strike plate combination which are removably secured to a door jamb to correct improper or incomplete closure of a door.

### BACKGROUND OF INVENTION

Modern residential doors are typically equipped with bored cylindrical or tubular chassis lockset systems, which utilize a strike plate component. Strike plates are mounted on a door frame, receive the latch bolts mounted to the door knob assembly and allow doors to close and latch in a secure fashion. This prevents undesired movement of a door and allows for other devices, such as door locks, to be utilized to provide further security. If a door is not able to be closed and secured properly, a loss of security, privacy and home value can occur.

However, as doors are used and routinely opened or closed, various components of the door can wear out or fatigue. Doorknob assemblies and door hinges experience mechanical wear that may cause misalignment of a door latch bolt with the strike plate, preventing proper securing of the door. Door latch bolts can change position over time, preventing a secure closure of the door. A door latch bolt may become misaligned with the strike plate due to compression or expansion of a door frame over time, typically caused by house settling and temperature variation. Additionally, doors themselves often compress or expand over time, leaving a latch in a position where it no longer can be seated and secured in a strike plate. Door hardware upgrades, door mounted hooks, and weather stripping replacement can also lead to misalignments. Misalignments of a door latch with a door strike plate by as little as a fraction of a millimeter can prevent a door from latching or securing properly. Thus, when any of these conditions occurs, expensive repairs or replacement of the door latch, door knob assembly, or entire door itself are often necessary. Such solutions are often time consuming, complex, and difficult to plan for many homeowners. Further, such repairs may only be effective as short term solutions and often fail at unexpected or undesired times. What is needed is a strike plate assembly, and method of use, that compensates for movement of the door or jamb and permits the door to be closed and locked.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The invention is directed toward an apparatus for receiving a door latch bolt comprising a subplate and a strike plate. The subplate is formed from a metal blank comprising a front side having a front edge and a front latching edge; a rear side having a rear edge and rear latching edge; a bolt aperture; an adjustable tab connected to the front side by a top tab fold line and a bottom tab fold line; a tab aperture disposed between the adjustable tab and the front side; a top fastener hole; and a bottom fastener hole. The strike plate comprises a bolt aperture having a back edge and a front latching edge; an outer face; an inner face; a curved front portion curving toward the inner face; a top screwhole; and a bottom screwhole.

In another embodiment of the invention, the bolt aperture of the strike plate has a curved top edge extending from the back edge to the front latching edge and a curved bottom edge extending from the back edge to the front latching edge, wherein the curved top edge is disposed on an opposite side of the bolt aperture than the curved bottom edge. In another embodiment of the invention, the strike plate further comprises a first lip extending from the top screwhole and disposed on the inner face and a second lip extending from the bottom screwhole and disposed on the inner face.

In another embodiment of the invention, the first lip is configured to be aligned with the top fastener hole and the second lip is configured to be aligned with the bottom fastener hole when the strike plate and the subplate are removably secured to a door jamb. In another embodiment of the invention, a portion of the first lip is disposed within the top fastener hole and a portion of the second lip is disposed within the bottom fastener hole when the strike plate and the subplate are removably secured to a door jamb.

In another embodiment of the invention, the strike plate is unmovable in a plane parallel to the subplate when the inner face of the strike plate is placed against a face of the subplate. In another embodiment of the invention, the adjustable tab is configured to be disposed at a substantially right angle from the front side by bending the top tab fold line and the bottom tab fold line.

In another embodiment of the invention the front side and the rear side of the subplate vary in widths to allow for a variation in compensation of horizontal closure. As one example, and in no way limiting the scope of the invention, the front side of the subplate may extend approximately ⅛ inches beyond the front latching edge into the bolt aperture of the strike plate when the subplate and the strike plate are removably secured to a door jamb in a first configuration. Additionally, the rear side of the subplate may extend approximately 1/16 inches beyond the front latching edge into the bolt aperture of the strike plate when the subplate and the strike plate are removably secured to a door jamb in a second configuration.

The invention is also directed toward a method for ensuring that a door fits tightly within a door jamb when in a closed position. The method comprises placing a subplate against a door jamb at a location to receive a door latch bolt, placing a strike plate against the subplate such that the subplate is disposed between the strike plate and the doorjamb, and removably securing the subplate and the strike plate to the door jamb.

The method may further comprise bending the top tab fold line and the bottom tab fold line such that the adjustable tab extends toward the door jamb when the subplate is removably secured to the door jamb. Alternatively, the method may further comprise bending the top tab fold line and the bottom tab fold line such that the adjustable tab extends away from the door jamb when the subplate is removably secured to the door jamb.

The method may further comprise placing the front side of the subplate adjacent to the curved portion of the strike plate prior to removably securing the subplate and the strike plate to the door jamb. Alternatively, the method may further comprise placing the rear side of the subplate adjacent to the curved portion of the strike plate prior to removably securing the subplate and the strike plate to the door jamb.

In another embodiment, the method may further comprise placing a portion of the first lip within the top fastener hole and a portion of the second lip within the bottom fastener hole such that the strike plate is unmovable in a plane parallel to the subplate when the inner face of the strike plate is placed against a face of the subplate.

Still other embodiments of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a perspective view of a strike plate;

FIG. 2A is a top plan view of a strike plate;

FIG. 2B is a front edge view of a strike plate;

FIG. 2C is a bottom edge view of a strike plate;

FIG. 3 is a perspective view of a strike plate removably secured to a door jamb;

FIG. 4A is a top plan view of a subplate;

FIG. 4B is a top plan view of a subplate with the adjustable tab in a bent position;

FIG. 4C is a front edge view of a subplate with the adjustable tab in a bent position;

FIG. 4D is a bottom edge view of a subplate with the adjustable tab in a bent position;

FIG. 5 is a perspective view of a subplate with the adjustable tab in a bent position;

FIG. 6 is a perspective view of a subplate and a strike plate being attached to a doorjamb;

FIG. 7 is a perspective view of a subplate and strike plate removably secured to a doorjamb; and

FIG. 8 is a schematic of a method of utilizing the invention.

### DETAILED DESCRIPTION OF THE PREFERRED EMBODIMENT

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

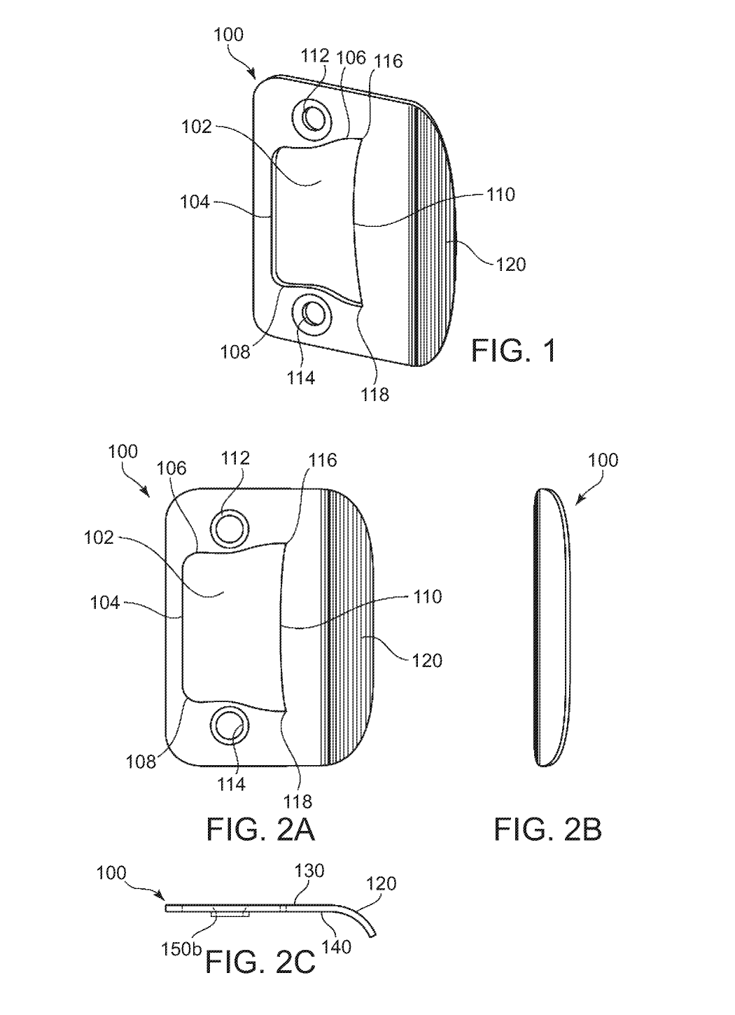

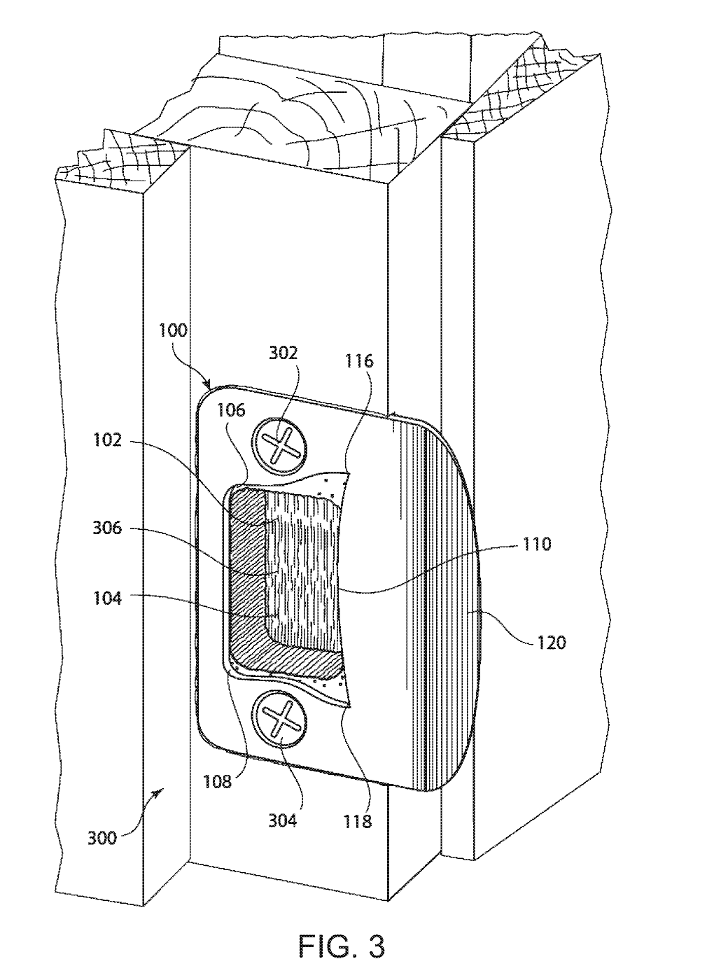

Referring now to exemplary FIG. 1 and exemplary FIGS. 2A, 2B, and 2C, an embodiment of a door strike plate 100 is illustrated. The door strike plate 100 may be formed out of any material, for example a metal, such sixteen gauge steel, or any other desired or known material or combination of materials. For example, the use of a substantially thick material, such as sixteen gauge or similar thickness (including fifteen gauge steel and fourteen gauge steel, by way of example), may provide an overall thickness of door strike plate that is greater than that of known door strike plates. Additionally, such a material may help a latch bolt to achieve a sufficient embed depth to securely seat in door strike plate 100 where a mortise recess or portion thereof may not exist underneath, and also provide further strength and durability to door strike plate 100, as well as maintaining strength and integrity under pressure.

The strike plate 100 may have bolt aperture 102, which may be disposed through the body of door strike plate 100. The bolt aperture 102 may be formed in any desired or known fashion during the manufacturing process. The bolt aperture 102 may be formed in such a shape that it has a flat back edge 104, a curved top edge 106, a curved bottom edge 108, and front latching edge 110. For example, the curved top edge 106 and the curved bottom edge 108 may be angled substantially towards a center portion of bolt aperture 102 in their middle portions, and may extend down and away from a center portion of bolt aperture 102 and terminating at distal ends 116, 118 of the front latching edge 110, respectively. In other words, in some exemplary embodiments, the curved top edge 106 and the curved bottom edge 108 may have widths that increase from back edge 104 to front latching edge 110. The curves of curved top edge 106 and curved bottom edge 108 may substantially mirror each other in shape and increasing width from back to front. Also, in some further exemplary embodiments, the front latching edge 110 may also act as an expansion area that may be reshaped or adjusted to provide further size to opening of bolt aperture 102, allowing for additional ease of fitting a previously-misaligned latch bolt.

Still referring to exemplary FIG. 1, the strike plate 100 may further include any desired attachment mechanism or capability, such as a top screw hole 112 and a bottom screw hole 114. Screw holes 112 and 114 may allow for the strike plate 100 to be securely attached or coupled to a door frame, or any other location, as desired. As above, the thickness of door strike plate 100 can also increase the thickness of screw holes 112 and 114, allowing for greater durability and strength. Additionally, it may be appreciated that any coupling or attachment mechanisms may be utilized, as desired. Further, it may be appreciated that screw holes 112 and 114 may be formed in any shape and size. For example, screw holes 112 and 114 may be formed as oval shapes, or otherwise formed in a substantially oblong shape, or any other appropriate shape, which can allow for the mounting of door strike plate 100 in an adjustable fashion, for example vertically or horizontally. Such adjustable placement or movement of door strike plate 100 can allow for bolt aperture 102 to securely seat and embed door latch bolts that are aligned or misaligned in the vertical or horizontal axis, or any combination thereof. For the purpose of clarity, and by no means to limit the scope of the invention, horizontal adjustment shall be that adjustment made along the path of the latch bolt as the latch bolt travels side to side when the door swings from an open position to a closed position. Vertical adjustment shall be that adjustment made in a direction upward or downward along a plum line.

As shown by FIG. 2C, the strike plate 100 has an outer face 130. The outer face 130 is the surface of the strike plate 100 which is disposed toward the door latch when the strike plate 100 is secured to a door frame. The strike plate 100 also has an inner face 140. The inner face 140 is disposed on an opposite surface than the outer face 130. The inner face 140 is the surface of the strike plate 100 which is disposed toward the door frame when the strike plate 100 is secured to a door frame. As also illustrated in FIG. 2C, the strike plate 100 may have a first lip 150a (not shown) extending from the top screw hole 112 and disposed on the inner face 140 and a second lip 150b extending from the bottom screw hole 114 and disposed on the inner face 140. The first lip 150a and second lip 150b may be any size and shape. The first lip 150a and second lip 150b may be bevels, tapers, edges, or any other shape extending from the respective screw holes 112, 114.

Also, as shown in exemplary FIG. 1, and further with respect to exemplary FIGS. 2B and 2C, the strike plate 100 may have curved front portion 120. The curved front portion 120 may be formed in any desired manner and may allow for a secure seating of the strike plate 100 against a door frame or any other desired location. In the preferred embodiment the curved front portion 120 curves toward the inner face 140 As in previous exemplary embodiments, the curved front portion 120 may have a thickness to it that provides for additional strength and durability. However, it may be appreciated that the curved front portion 120 may be formed with any desired thickness so as to be fitted or seated against a door frame in a desired fashion, for example flush with a door frame or cutout area on the door frame to provide desired functionality, strength, security, and aesthetics.

Referring now to exemplary FIGS. 1 and 2A, the bolt aperture 102 may be formed to have a variety of features and to allow for a variety of capabilities. For example, the front latching edge 110, terminating in distal ends 116 (top) and 118 (bottom), may accommodate a latch bolt of a doorknob assembly (not pictured) that could not be secured in a standard door strike plate. The curvature of curved front side 120 of the strike plate 100 allows for bolt aperture 102 to accommodate and securely seat a misaligned latch bolt from a doorknob assembly. For example, if a latch bolt of a doorknob assembly is skewed in any fashion, front latching edge 110, along with curved top edge 106 and curved bottom edge 108 may allow for the skewed latch bolt to enter bolt aperture 102 and be seated, allowing for a desired operation of the doorknob latch assembly. Such skewing may be caused by any of a variety of reasons, for example wear on the door or doorknob latch assembly. Wear on door hinges, or door frames warping out of square, commonly due to house settling, often causes door latch bolt misalignment and latch failure. Alternatively, a previously-fitted door strike plate or a new strike plate installed during a door hardware replacement may have been otherwise improperly attached, leading to misalignment with that door strike plate. The bolt aperture 102 of the strike plate 100 therefore provides a greater area for the latch bolt so that if it is misaligned with a previous door strike plate, the strike plate 100 can receive and secure a latch bolt. In such examples, if a latch bolt strikes the strike plate 100 high or low, the latch bolt would still proceed to enter bolt aperture 102 in the present example, whereas such placement would prevent a door from being closed and secured in other existing door strike plates. Additionally, if there are any items mounted on a door that can affect its typical, desired range of motion and position of the latch bolt, such as hooks commonly mounted at the top of a door or new or misaligned weather stripping, then the strike plate 100 can accommodate the change in position or displacement of a latch bolt caused by the hooks and provide a secure seating for the latch bolt in bolt aperture 102.

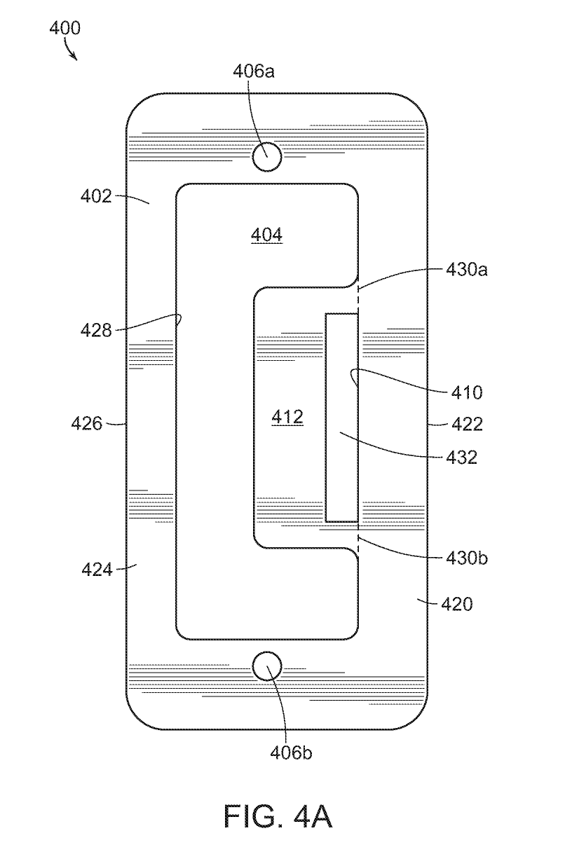

Still referring to exemplary FIGS. 1 and 2A, a latch bolt striking high or low would be accommodated by the strike plate 100. As distal ends 116 and 118 provide upward and outward openings in the bolt aperture 102, a door latch bolt that is misaligned with a center portion of bolt aperture 102 may still be securely seated in the bolt aperture 102. Further, in some exemplary embodiments, distal ends 116 and 118, as well as their surrounding areas, may act as or be referred to as one or more mortise cutout guides. In such exemplary embodiments the strike plate 100 may be mounted on a door frame or a cutout area on a door frame. The bolt aperture 102 of door strike plate 100 may thus provide a wider opening, or open an area that is larger than a standard, known, rectangular mortise. A user can then mark the door frame, or otherwise use the shape of bolt aperture 102, including distal ends 116 and 118 to act as a guide for expanding the mortise. This is shown in more detail in exemplary FIG. 3. However, it may further be appreciated that, even if a mortise is not expanded to reflect the size of the bolt aperture 102, a door latch bolt may still catch on the thickness of the metal and provide for a secure closing against the front latching edge 110 of the bolt aperture 102.

Referring now to exemplary FIG. 3, a door strike plate 100 may be shown as mounted against a door frame 300. The strike plate 100 may include all of the elements described in the various exemplary embodiments herein. Additionally, the screws 302, 304 may be used to secure door strike plate 100 to the door frame 300. Further, mortise 306 is shown in a center portion of bolt aperture 102, however mortise 306 is smaller than bolt aperture 102. As described above, the elements of bolt aperture 102 can thus be used as a guide to expand mortise 306. However, in some exemplary embodiments, mortise 306 may not be altered and a door latch bolt may securely embed and seat in bolt aperture 102 and mortise 306. Alternatively, a door latch bolt may partially embed in mortise 306 but still securely seat or latch against front latching edge 110 of bolt aperture 102. Thus, door strike plate 100 can provide secure latching of a door using bolt aperture 102 without a mortise 306 shaped substantially like bolt aperture 102.

In still another exemplary embodiment, a method of using a door strike plate 100 may be described. In this method, an old door strike plate which does not allow for proper or desired latching may be removed and discarded. Door strike plate 100 may then be fitted to a door frame 300 (also known as a door jamb), for example as shown in FIG. 3. A pair of screws may then be used respectively in the top screw hole 112 and the bottom screw hole 114 to secure the strike plate 100 to door frame 300. It may be appreciated in other exemplary methods that different attachment devices or compounds may be utilized. After the strike plate 100 is securely mounted, a door latch bolt that was previously misaligned may now function properly or as desired. Additionally, the strike plate 100 may be adjusted, for example vertically, so as to provide a proper receiving area in the bolt aperture 102 and mortise 306 for a door latch bolt. After the strike plate 100 is mounted and the fitting is evaluated with respect to the mortise 306 and a door latch bolt, bolt aperture 102 may also serve as a guide to expanding or changing the shape of mortise 306, as desired. In such exemplary embodiments, the door frame 300 and an area around mortise 306 may be marked, the strike plate 100 may be removed, and the mortise 306 may be expanded, as desired. The strike plate 100 may then be remounted on the door frame 300, as desired.

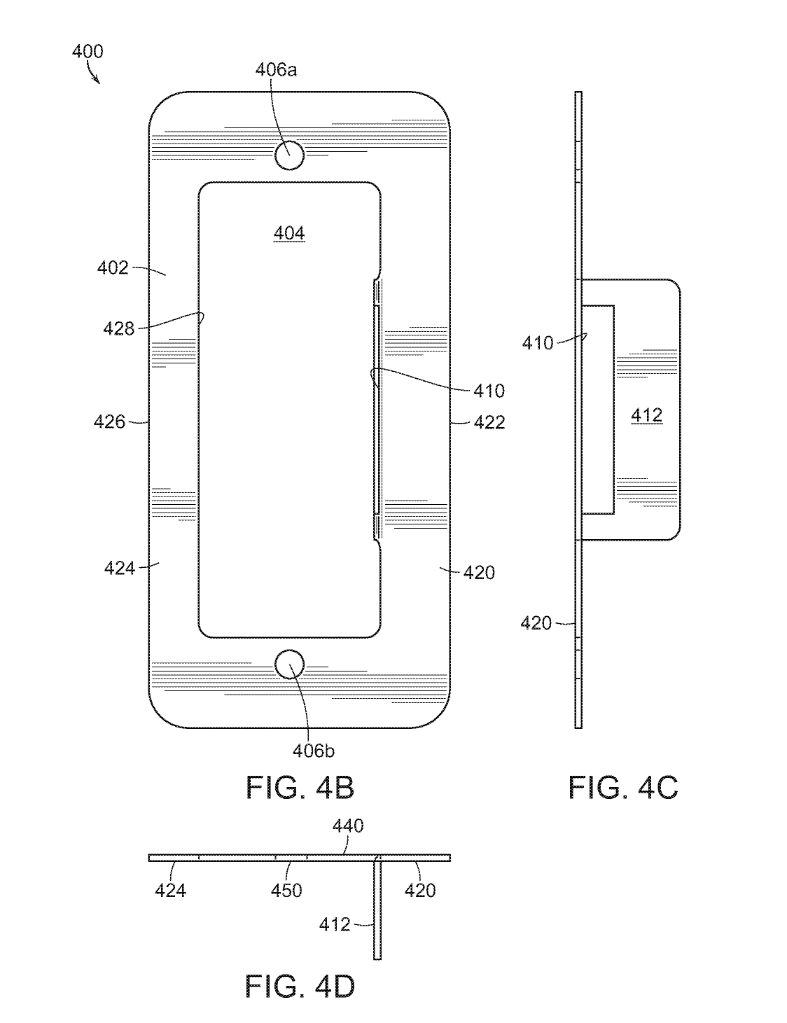

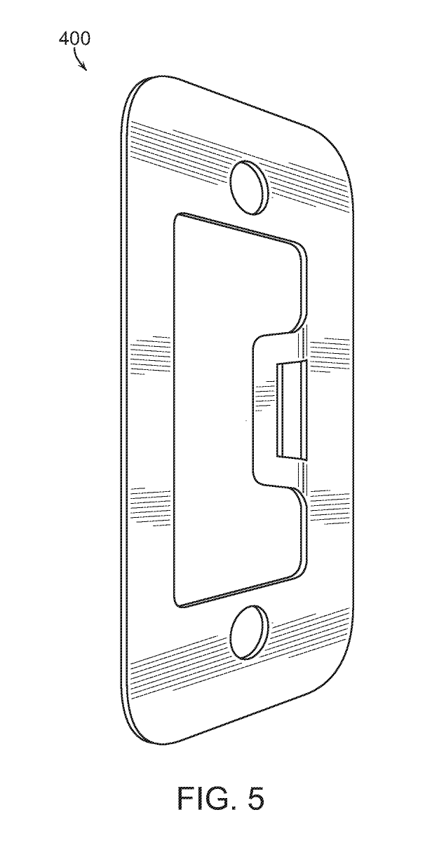

Now generally referring to exemplary FIGS. 4-5, a subplate 400 may be provided to work in conjunction with strike plate 100 to compensate and account for horizontal looseness and excessive door/doorframe gaps causing a door latch bolt to fail to reach sufficient imbed depth in a strike plate. Door/doorframe gap compensation may result from the thickness of the subplate 400, while horizontal compensation may result from the location of a latching edge in relation to the thickness of a door frame 300, as would be understood by a person having ordinary skill in the art. Door warping, weather stripping, door attachments, new hardware, and other factors, as would be understood by a person having ordinary skill in the art, may cause horizontal misalignment between a door latch and a strike plate 100. The misalignment may result in extra space leading to looseness or a failure of a latch's ability to reach and engage a strike plate 100. A subplate 400 may be installed between a strike plate 100 and a door frame 300 so both plates installed together provide vertical and horizontal compensation, restoring latching function on doors with all types of misalignments.

An exemplary subplate 400 may include a substantially planar plate or body from a metal blank 402 having a bolt aperture 404 capable of receiving a latch. The subplate 400 may further include a top fastener hole 406a and a bottom fastener hole 406b for allowing screws 302, 304 or other desired strike-plate fasteners to pass through, securing subplate 400 between a strike plate 100 and a door frame 300. In an exemplary embodiment, the top fastener hole 406a and/or the bottom fastener hole 406b may be aligned to coincide with fastener holes 112, 114 disposed in a strike plate. Yet further, at least one fastener hole 406a, 406b may be shaped or sized to allow for adjustments in the orientation of a subplate, without adjusting the location of screws or fasteners 302, 304 on a door frame. In some exemplary embodiments, the bolt aperture 404 may be shaped and sized to substantially coincide with the bolt aperture 102 of the strike plate 100. When installed, a front latching edge 410 of the bolt aperture 404 may be disposed within the perimeter of bolt aperture 102. This additional latching edge may result in a tiered, two-step latching system.

A door latch bolt is provided an additional latching edge by the subplate 400, further in along the face of a door frame, which may significantly eliminate looseness and rattle. When closing, a door latch bolt may cause a double-click sound, indicating that both latching edges 110, 410 have been engaged. If a latch bolt is not able to engage front latching edge 410 the latch bolt may still engage latching edge 110, allowing the door to function properly, even if the subplate 400 is not needed.

A subplate 400 may also include an adjustable tab 412 to further reduce looseness. The adjustable tab 412 may protrude from and be bent in relation to a front latching edge 410, as would be understood by a person having ordinary skill in the art. Bending the adjustable tab 412 may further adjust the engagement location of a latch bolt by causing the latch bolt to engage the adjustable tab 412. The adjustable tab 412 is connected to the front side 420 by a top tab fold line 430a and a bottom tab fold line 430b. The top tab fold line 430a and a bottom tab fold line 430b are configured to provide points permitting the adjustable tab 412 to moved to a position so that it is disposed towards the door frame or away from the door frame. Although the embodiment illustrates a top tab fold line 430a and a bottom tab fold line 430b, there may be any number of tab fold lines connecting the adjustable tab 412 to the front side 420. Disposed between the adjustable tab 412 and the front side 420 is a tab aperture 432. In an embodiment with multiple tab fold lines, there may be more than one tab aperture 432.

As illustrated in FIG. 4D, the subplate 400 has a plate face 440 and a jamb face 450. The plate face 440 is the surface of the subplate 400 which is disposed toward the strike plate 100 when the subplate 400 is secured to a door frame. The jamb face 450 is the surface of the subplate 400 which is disposed on the opposite side from the plate face 440. The jamb face is the surface of the subplate 400 which is disposed toward the door frame when the subplate 400 is secured to the door frame.

In an exemplary embodiment, the horizontal compensation of a front side 420 of the metal blank 402, which may be the portion of the metal blank 402 between the bolt aperture 404 and a front edge 422, may be greater than that of a rear side 424, which may be the portion of the metal blank 402 between the bolt aperture 404 and a rear edge 426. In such embodiments, the subplate 400 may be reversible to provide further variation in the amount of horizontal compensation provided. For example, the subplate 400 may be reversed, or rotated 180 degrees about the face of a door frame, to provide a different amount of horizontal compensation. When reversed, the rear side 424 may create a rear latching edge 428 for engaging a latch bolt. In an exemplary embodiment, with the subplate 400 installed between the strike plate 100 and a door frame 300, a front side 420 may provide ⅛ inches of horizontal compensation to eliminate looseness or rattle. If reversed 180 degrees, placing a rear side 424 to the front toward the latch bolt, then the rear side 424 provides 1/16 inches of horizontal compensation. This amount of compensation is the distance measured from the front latching edge 110 to the latching edge of the subplate 400 utilized.

An installer may choose which orientation provides the best performance in relation to eliminating door looseness or rattle. Such a reversed orientation would rotate the adjustable tab 412 away from the door latch, eliminating its possible use. In other exemplary embodiments, rear side 424 may also have an adjustable tab. In other exemplary embodiments, the horizontal compensation of a front side 420 and rear side 424 may be any desired amount, as would be understood by a person having ordinary skill in the art. This may allow for secure latching when some compensation is necessary, but not the full horizontal compensation amount of front side 420. In such embodiments, the adjustable tab 412 may only be functional in a front orientation, when front latching edge 410 serves as the latching edge.

In another embodiment of the invention the first lip 150a of the strike plate 100 engages with the top fastener hole 406a and the second lip 150b of the strike plate 100 engages with the bottom fastener hole 406b. In one embodiment a portion of the first lip 150a can be placed within the top fastener hole 406a and a portion of the second lip 150b can be placed within the bottom fastener hole 406b. The placement of the respective lips 150a, 150b within the respective fastener holes 406a, 406b ensures that the strike plate 100 and the subplate 400 can be snugly fit together such that neither the strike plate 100 nor the subplate 400 can move in a planar direction relative to each other, preventing the sliding of either plate while in use on a door frame and further enhancing the force by which the combined plates can hold a door latch.

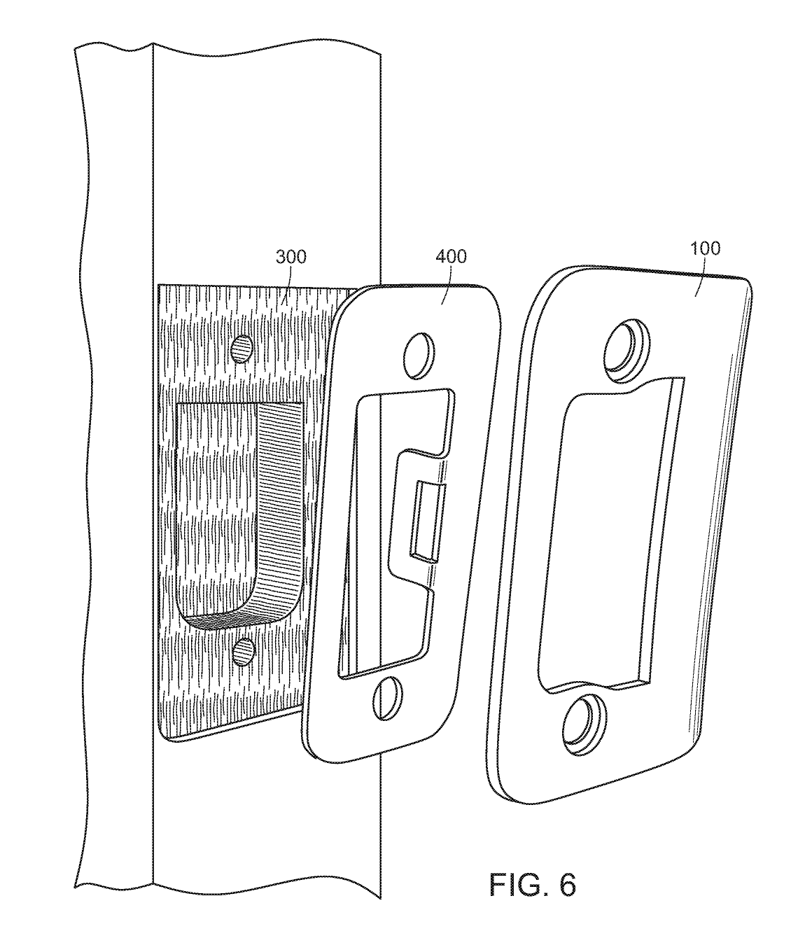

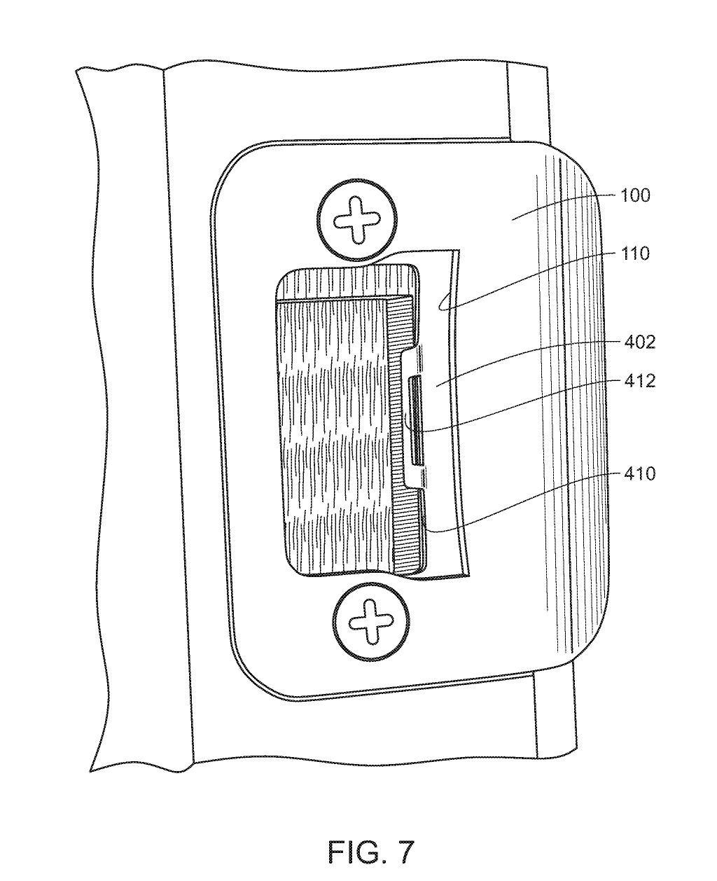

Referring to FIG. 6, a user, during the installation process, positions the subplate 400 in the desired configuration with relation to the position of the front side 420 and rear side 424 and position of the adjustable tab 412. The user places the subplate 400 in the desired position between the door frame 300 and the strike plate 100. Referring to FIG. 7, the invention after full installation on a door frame 300 is illustrated. The strike plate 100 is disposed on the outside of the subplate 400. The subplate 400 is disposed between the strike plate 400 and the door frame 300. The strike plate 100 presents a front latching edge 110 while the subplate 400 also presents a front latching edge 410. The adjustable tab 412 is disposed inward toward the door frame 300.

In further exemplary embodiments, the subplate 400 may be permanently affixed to the strike plate 100, such as by welding, or integrally formed with strike plate 100. Affixing the subplate 400 to the strike plate 100 or integrally forming the subplate 400 with the strike plate 100 may simplify installation by limiting the installation to one part, while maintaining the two-layer metal edge and two-step latching system.

The subplate 400 may be made of a variety of materials, such as metal, or other materials as would be understood by a person having ordinary skill in the art. In an exemplary embodiment, the subplate 400 may be zinc-plated. The subplate 400 and the strike plate 100 may be made of the similar material or may be made of different materials, as desired. In an exemplary embodiment, the subplate 400 may have a 1 mm sheet metal thickness, which may reduce door/doorframe gaps. In other exemplary embodiments, the subplate 400 may have any desired thickness as would be understood by a person having ordinary skill in the art.

The subplate 400 may be used with a strike plate 100, as described above. Alternatively, a subplate 400 may be used with any desired strike plate embodiment, as would be understood by a person having ordinary skill in the art. The subplate 400 may be utilized with a specialized strike plate 100 or with a standard strike plate provided with a commercially available door frame.

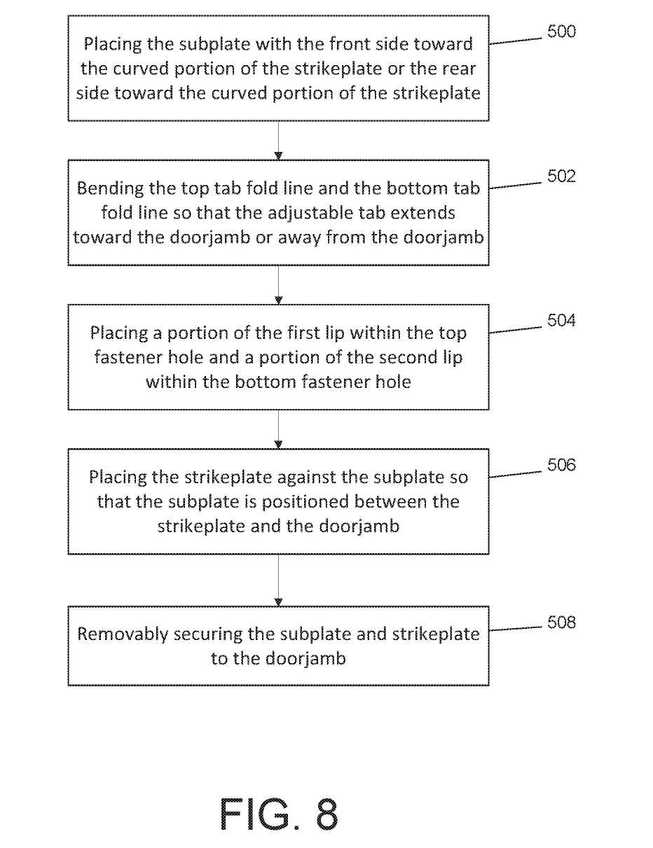

Referring to FIG. 8, the method of utilizing the invention is illustrated. First, the user places the subplate with the front side toward the curved portion of the strike plate or the rear side toward the curved portion of the strike plate 500. In this method the user may use a specialized strike plate with a shaped latch bolt aperture or a standard preexisting strike plate. The user may start this method as a new installation of the strike plate or may remove a preexisting strike plate and add subplate to the preexisting strike plate. Once the user has the subplate in the desired orientation to correct for horizontal movement, then the user can bend the top tab fold line and the bottom tab fold line so that the adjustable tab extends toward the door jamb or away from the door jamb 502. In the embodiment of the invention where the first lip and second lip engage with the respective screwholes of the subplate, the user then places a portion of the first lip within the top fastener hole and a portion of the second lip within the bottom fastener hole 504. The user then places the subplate against the door jamb and places the strike plate against the subplate so that the subplate is positioned between the strike plate and the door jamb 506. The user then removably secures the subplate and strike plate to the door jamb 508. The subplate and strike plate are preferably secured by means of screws though other methods may be utilized, such as the use of tape, hook and loop tape, glue, caulking, nailing, stapling, or any other means of temporarily or permanently securing the subplate and the strike plate to the door jamb.

From a general view of the installation of the invention, the user first stacks the strike plate on top of the subplate 400 so that the screwholes of the subplate align with the respective fastener holes of the strike plate 100. The user then inserts screws 302, 304 through the respective holes and begins threading the screws. The user may being threading the screws 302, 304 manually with the user's fingers or using a tool such as a screwdriver. The user then places the combined subplate 400 and strike plate 100 on a door jamb 300. The user can use a screwdriver or electric drill with a #2 bit to removal secure the subplate 400 and strike plate 100 combination to a recess in the door jamb 300. The user optionally may take proper measurements or use a stencil prior to this step to ensure proper placement of the combined apparatus. After installing the combined apparatus, the user then closes the door to ensure that the door latch bolt enters the each bolt aperture 102, 404. The user listens for a double-clicking sound of the door latch bolt engaging each latching edge 110, 410. If the user hears two metallic clicks then the installation of the combined apparatus is complete. Optionally the user may bend the adjustable tab 412 outward, toward the door to eliminate looseness. If the user hears only one click then the user removes the combined apparatus and reverses the orientation of the subplate 400 in relation to the strike plate 100 by turning it 180 degrees. The user then removably secures the combined apparatus to the door jamb 300. The user closes the door again, listening for a double clicking sound. If two clicks are still not heard the user may remove the combined apparatus, discard the subplate 400, and reattach the strike plate 100 only to the door jamb 300.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1) An apparatus for receiving a door latch bolt comprising
a) a subplate (400) formed from a metal blank (402)
i) wherein said metal blank (402) comprises
(1) a front side (420) having a front edge (422) and a front latching edge (410);
(2) a rear side (424) having a rear edge (426) and rear latching edge (428);
(3) a bolt aperture (404);
(4) an adjustable tab (412) connected to said front side (420) by a top tab fold line (430a) and a bottom tab fold line (430b);
(5) a tab aperture (432) disposed between said adjustable tab (412) and said front side (420);
(6) a top fastener hole (406a);
(7) a bottom fastener hole (406b);
b) a strike plate (100) comprising
i) a bolt aperture (102) having a back edge (104) and a front latching edge (110);
ii) an outer face (130);
iii) an inner face (140);
iv) a curved front portion (120) curving toward said inner face (140);
v) a top screw hole (112); and
vi) a bottom screw hole (114).

2) The apparatus as in claim 1 wherein said bolt aperture (102) of said strike plate (100) has a curved top edge (106) extending from said back edge (104) to said front latching edge (110) and a curved bottom edge (108) extending from said back edge (104) to said front latching edge (110), wherein said curved top edge (106) is disposed on an opposite side of said bolt aperture (102) than said curved bottom edge (108).

3) The apparatus as in claim 2 wherein said strike plate (100) further comprises a first lip (150a) extending from said top screw hole (112) and disposed on said inner face (140) and a second lip (150b) extending from said bottom screw hole (114) and disposed on said inner face (140).

4) The apparatus as in claim 3 wherein said first lip (150a) is configured to be aligned with said top fastener hole (406a) and said second lip (150b) is configured to be aligned with said bottom fastener hole (406b) when said strike plate (100) and said subplate (400) are removably secured to a door jamb.

5) The apparatus as in claim 4 wherein a portion of said first lip (150a) is disposed within said top fastener hole (406a) and a portion of said second lip (150b) is disposed within said bottom fastener hole (406b) when said strike plate (100) and said subplate (400) are removably secured to a door jamb.

6) The apparatus as in claim 5 wherein said strike plate (100) is unmovable in a plane parallel to said subplate (400) when said inner face (140) of said strike plate (100) is placed against a face of said subplate (400).

7) The apparatus as in claim 6 wherein said adjustable tab (412) is configured to be disposed at a substantially right angle from said front side (420) by bending said top tab fold line (430a) and said bottom tab fold line (430b).

8) The apparatus as in claim 7 wherein said front side (420) has a width which is unequal to a width of said rear side (424).

9) The apparatus as in claim 8
a) wherein a portion of said front side (420) of said subplate (400) extends approximately ⅛ inches beyond said front latching edge (110) into said bolt aperture (102) of said strike plate (100) when said subplate (400) and said strike plate (100) are removably secured to a door jamb in a first configuration;
b) wherein a portion of said rear side (424) of said subplate (400) extends approximately 1/16 inches beyond said front latching edge (110) into said bolt aperture (102) of said strike plate (100) when said subplate (400) and said strike plate (100) are removably secured to a door jamb in a second configuration.

10) An apparatus for receiving a door latch bolt comprising
a) a strike plate comprising
i) a shaped body;
ii) a shaped strike plate opening;
iii) two screw holes;
b) a subplate comprising
i) a shaped body comprising
(1) a front portion;
(2) a top portion;
(3) a bottom portion;
(4) a rear portion;
ii) a shaped subplate opening;
iii) an adjustable tab connected to said front portion of said shaped body;
iv) a first fastener hole disposed in said top portion of said shaped body;
v) a second fastener hole disposed in said bottom portion of said shaped body.

11) The apparatus of claim 10 wherein said shaped subplate opening is defined by a front latching edge disposed on said front portion of said shaped body, a rear latching edge disposed on said rear portion of said shaped body, a top inner edge disposed on said top portion of said shaped body, and a bottom inner edge disposed on said bottom portion of said shaped body.

12) The apparatus of claim 10
a) wherein a front portion of said shaped body of said subplate extends approximately ⅛ inches into said shaped strike plate opening beyond a front latching edge of said strike plate when said subplate and said strike plate are removably secured to a door jamb in a first configuration;
b) wherein a rear portion of said shaped body of said subplate extends approximately 1/16 inches into said shaped strike plate opening beyond a front latching edge of said strike plate when said subplate and said strike plate are removably secured to a door jamb in a second configuration.

13) The apparatus of claim 10 wherein said front portion of said shaped body of said subplate is wider than said rear portion of said shaped body of said subplate.

14) The apparatus of claim 10 wherein said adjustable tab is connected to said front portion of said shaped body by a first bendable connection disposed at a first end of said adjustable tab and a second bendable connection disposed at a second end of said adjustable tab.

15) A method for ensuring a door fits tightly within a door jamb when in a closed position comprising
a) placing a subplate (400) against a door jamb at a location to receive a door latch bolt, said subplate (400) comprising
(1) a front side (420) having a front edge (422) and a front latching edge (410);
(2) a rear side (424) having a rear edge (426) and rear latching edge (428);
(3) a bolt aperture (404);
(4) an adjustable tab (412) connected to said front side (420) by a top tab fold line (430a) and a bottom tab fold line (430b);
(5) a tab aperture (432) disposed between said adjustable tab (412) and said front side (420);
(6) a top fastener hole (406a);
(7) a bottom fastener hole (406b);
b) placing a strike plate (100) against said subplate (400) such that said subplate (400) is disposed between said strike plate (100) and said door jamb, said strike plate (100) comprising
i) a bolt aperture (102) having a back edge (104) and a front latching edge (110);
ii) an outer face (130);
iii) an inner face (140);
iv) a curved front portion (120) curving toward said inner face (140);
v) a top screw hole (112);
vi) a bottom screw hole (114); and
c) removably securing said subplate (100) and said strike plate (400) to said door jamb;
d) ensuring proper utilization by listening for a double-clicking sound of a door latch bolt engaging said strike plate (100) and said subplate (400).

16) The method as in claim 15 further comprising bending said top tab fold line (430a) and said bottom tab fold line (430b) such that said adjustable tab (412) extends toward said door jamb when said subplate (400) is removably secured to said door jamb.

17) The method as in claim 15 further comprising bending said top tab fold line (430a) and said bottom tab fold line (430b) such that said adjustable tab (412) extends away from said door jamb when said subplate (400) is removably secured to said door jamb.

18) The method as in claim 15 further comprising placing said front side (420) of said subplate (400) adjacent to said curved portion (120) of said strike plate (100) prior to removably securing said subplate (400) and said strike plate (100) to said door jamb.

19) The method as in claim 15 further comprising placing said rear side (424) of said subplate (400) adjacent to said curved portion (120) of said strike plate (100) prior to removably securing said subplate (400) and said strike plate (100) to said door jamb.

20) The method as in claim 15 further comprising
a) placing a portion of said first lip (150a) within said top fastener hole (406a) and a portion of said second lip (150b) within said bottom fastener hole (406b) such that said strike plate (100) is unmovable in a plane parallel to said subplate (400) when said inner face (140) of said strike plate (100) is placed against a face of said subplate (400).
